(19) United States
(12) Patent Application Publication
(10) Pub. No.: US 2025/0375740 A1
(43) Pub. Date: Dec. 11, 2025

(54) MEMBRANES HAVING A CROSSLINKED BLOCK COPOLYMER AND PROCESSES FOR MAKING SAME

(71) Applicant: ENTEGRIS, INC., Billerica, MA (US)

(72) Inventors: Jad Ali Jaber, Westford, MA (US); Cesar Lopez Gonzalez, Bedford, MA (US)

(21) Appl. No.: 18/874,604

(22) PCT Filed: Jun. 15, 2023
(86) PCT No.: PCT/US2023/025445

§ 371 Date: Dec. 13, 2024

Related U.S. Application Data
(60) Provisional application No. 63/352,709, filed on Jun. 16, 2022.

(51) Int. Cl. B01D 69/02; B01D 63/14; B01D 69/10; B01D 69/12; B01D 71/26; B01D 71/28; B01D 71/80

(52) U.S. Cl. CPC B01D 69/02; B01D 69/1071; B01D 69/12; B01D 71/26; B01D 71/281; B01D 71/283; B01D 71/80; B01D 63/14; B01D 2325/04; B01D 2325/24; B01D 2325/28

(57) ABSTRACT

The disclosure provides certain block copolymer membranes which are useful as components of filters for liquid purification and/or filtration. The block copolymers of the disclosure are subjected to cross-linking reactions to raise the overall molecular weight and are thus believed to impart improved solvent resistance properties to the membranes, thereby rendering such membranes suitable for use with solvents such as photolithography solvents. Additionally, this cross-linking treatment is believed to improve the integrity of the pore structure of the membrane during a drying step.

### TECHNICAL FIELD

The present disclosure relates to filter membranes comprising certain block copolymers.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

To perform a filtration function, a filter may include a filter membrane that is responsible for removing unwanted material from a fluid that passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 microns. Membranes with average pore size of from about 0.001 to about 0.05 micron are sometimes classified as ultrafilter membranes. Membranes with pore sizes between about 0.05 and 10 microns are sometimes referred to as microporous membranes.

A filter membrane having micron or sub-micron-range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

Block copolymer self-assembly is a unique membrane formation technology with fine control over pore dimensions and pore size distribution. Polymer design is critical and careful consideration goes into designing macromolecules which microphase separate into periodic, ordered structures. One such polymer is poly (isoprene-b-styrene-b-4-vinyl pyridine), which is currently used to make filtration membranes in the life science and ultra-pure water markets. However, such polymers are not entirely suitable for use with many common solvents, such as photolithography solvents as the pore structures tend to collapse upon drying and/or the polymers may dissolve in the photolithography solvents. Accordingly, filter membranes comprising block copolymers and such highly ordered pore structures which would be compatible with such common solvents would be highly desirable.

### SUMMARY

In summary, the disclosure provides certain block copolymer membranes which are useful as components of filters for liquid purification and/or filtration. The block copolymers of the disclosure are subjected to cross-linking reactions to raise the overall molecular weight and are thus believed to impart improved solvent resistance properties to the membranes, thereby rendering such membranes suitable for use with solvents such as photolithography solvents. Additionally, this cross-linking treatment is believed to improve the integrity of the pore structure of the membrane during a drying step.

### BRIEF DESCRIPTION OF THE DRAWINGS

FIG. 1 (which is schematic and not necessarily to scale) shows an example of a filter product as described herein.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In a first aspect, the disclosure provides a membrane comprising a cross-linked block copolymer, wherein the membrane exhibits less than about 20 percent change in bubble point when exposed to one or more photolithography solvents for a period of 24 hours. As will be more fully described below, the cross-linked block copolymer membranes can be prepared starting with block copolymers having carbon-carbon double bonds available for cross-linking reactions or possess anthracene moieties capable of dimerization reactions. The cross-linked block copolymer membranes of the disclosure are thus useful as filter membranes for various fluids and are believed to possess greater stability towards organic solvents as well as possessing greater drying stability when compared to non-cross-linked membranes.

The membranes of the disclosure are believed to possess drying stability which alleviates substantially all necessity for the use of humectants, such as glycerin, which are often used in conventional membranes in order to preserve the pore structure during fabrication and drying. Accordingly, in another embodiment, the disclosure provides the membranes of the disclosure wherein the cross-linked block copolymer contains less than about 10, less than about 5, or less than about 1 weight percent of a humectant. In this regard, the presence of such humectants in a given membrane can be detected by extraction of the humectant from the membrane and analyzing same by NMR and/or IR spectroscopy to determine the amount, if any, of humectant(s) present.

In addition to greater stability in the presence of organic solvents, such as photolithography solvents, the membranes of the disclosure are believed to exhibit improved performance when subjected to tensile testing, such as that contemplated in ASTM Method D638-14. As an additional quality of the cross-linked block copolymer membranes, we believe the membranes will exhibit a tensile strain at break of greater than about 5 percent, as determined by ASTM Method D638-14.

If the cross-linked block copolymer membrane possesses sufficient mechanical stability, it may be used directly as a component in a filtration device. Alternately, the block copolymer membrane may be cast upon a porous substrate or base layer to form a composite membrane and then subjected to a cross-linking reaction, in another aspect of the disclosure. Accordingly, in a further aspect, the disclosure provides a process for preparing a composite membrane comprising:
a. a porous base layer; and a
b. cross-linked block copolymer membrane layer; wherein the membrane exhibits less than about 20 percent change in bubble point when exposed to one or more photolithography solvents for a period of 24 hours;
which process comprises casting a bock copolymer having either residual carbon-carbon double bonds or anthracene moieties onto the porous base layer and subjecting the block copolymer membrane layer to a cross-linking reaction.

The casting of the cross-linked block copolymer membrane layer onto the porous base layer may be accomplished using known methodology. See, for example, “Tuning Structure and Properties of Graded Triblock Terpolymer-Based Mesoporous and Hybrid Films”, W. A. Phillip, et al., Nano Lett. 2011, 11, 2892-2900, which describes methodology for forming block copolymer films by use of a combination of controlled solvent evaporation and nonsolvent-induced phase separation (NIPS). In general, one can utilized the methodology described in the cited reference for casting a membrane onto a glass surface and substituting a porous base layer therefor, thereby forming a composite membrane comprising the porous base layer and the cross-linked block copolymer layer, which can then be subjected to a cross-linking reaction to afford the membranes of the disclosure.

Thus, in a further aspect, the disclosure provides a composite membrane comprising a porous base layer and a cross-linked block copolymer layer, wherein the membrane exhibits less than about 20 percent change in bubble point when exposed to one or more photolithography solvents for a period of 24 hours.

The porous substrate layer may be made of any conventional natural or synthetic porous material such as a nonwoven fibrous material or a porous polymeric membrane. Exemplary polymers in this context include polyolefins and halogenated polymers. Exemplary polyolefins include polyethylene, polypropylene, polymethylpentene, polybutene, polyisobutylene, and copolymers of two or more of ethylene, propylene, and butylene. In a further particular embodiment, porous substrate material comprises ultra-high molecular weight polyethylene (UPE). UPE filter materials, such as UPE membranes, are typically formed from a resin having a molecular weight (viscosity average molecular weight) greater than about 1×10⁶ Daltons (Da), such as in the range of about 1×10⁶-9×10⁶ Da, or 1.5×10⁶-9×10⁶ Da. In this porous polymeric base support or substrate layer, cross-linking between polyolefin polymers such as polyethylene can be promoted by use of heat or cross-linking chemicals, such as peroxides (e.g., dicumyl peroxide or di-tert-butyl peroxide), silanes (e.g., trimethoxyvinylsilane), or azo ester compounds (e.g., 2,2′-azo-bis(2-acetoxy-propane). Exemplary halogenated polymers include polytetrafluoroethylene (PTFE), polychlorotrifluoro-ethylene (PCTFE), fluorinated ethylene polymer (FEP), polyhexafluoropropylene, and polyvinylidene fluoride (PVDF).

Additionally, the porous substrate layer may be comprised of a polymer chosen from polyimides, polysulfones, polyether-sulfones, polyarylsulfone polyamides, polyacrylates, polyesters, polyamide-imides, celluloses, cellulose esters, polycarbonates, or combinations thereof.

As noted above, the membranes of the disclosure can be prepared via multiple alternative cross-linking reactions. Accordingly, in another aspect, the disclosure provides a process for preparing a cross-linked block copolymer membrane, the process comprising treatment of a block copolymer membrane having residual carbon-carbon double bonds to form a cross-linked block copolymer, wherein the treatment is chosen from the group consisting of
a. treatment with a sulfur compound at temperatures sufficient to induce cross-linking;
b. treatment with a thermal free radical initiator at sufficient temperatures to induce cross-linking;
c. treatment with ultraviolet light in the presence of a free radical photoinitiator; and
d. treatment with electron beam radiation.

In option a. above, treatment with a sulfur compound such as polymeric sulfur at temperatures sufficient to induce cross-linking, refers to conventional methods of vulcanization of natural and synthetic rubber as is well-understood. See, for example, U.S. Pat. Nos. 2,560,045; 4,238,470; 7,569,639; RE 25007E; 10,125,239; and 10,011,663, incorporated herein by reference in their entireties.

In option b., treatment with a thermal free radical initiator, refers to the use of thermally-activated free radical initiators such as benzoyl peroxide or azobisisobutytronitrile (AIBN), each of which decomposes at elevated temperatures to provide free radical flux, thus enabling a cross-linking reaction between carbon-carbon double bond moieties present within the polymer matrix. The block copolymer starting materials can be converted to a filter membrane and then, for example, treated with a solvent solution comprising the thermally-activated free radical initiator and then heated.

In option c., treatment with a photo free radical initiator can be accomplished in similar fashion by exposing the block copolymer membrane having residual carbon-carbon double bonds to a solution of a free radical initiator such as Irgacure® 2595 (Ciba) (2-hydroxy-4′-(2-hydroxyethoxy)-2-methylpropiophenone), benzophenone, or ammonium persulfate in the presence of ultraviolet light. The block copolymer starting materials can be converted to a filter membrane and then, for example, treated with a solvent solution comprising the photo-activated free radical initiator and then heated.

In option d., the block copolymer membrane having residual carbon-carbon double bonds can be exposed to electron beam radiation in the absence of initiator(s) in order to facilitate cross-linking. See, for example, “Effect of Electron Beam Radiation on Tensile and Viscoelastic Properties of Styrenic Block Copolymers”, J. Wu, et al., Polym. Eng. Sci., 54:2979-2988, 2014. In this regard, dosage levels can be utilized in a range of 40-240 kGy and adapted to the desired level of cross-link density and proportion of available carbon-carbon double bonds present within the polymer matrix.

Alternately, in one embodiment of the disclosure, the block copolymer which is utilized to form the filter membrane is designed with at least a portion of its composition comprising residues of monomeric materials comprising anthracene moieties. Such polymers comprising these anthracene moieties can be effectively cross-linked by subjecting the resulting block copolymer with ultraviolet light which effects a dimerization reaction between the anthracene moieties present within the polymeric matrix. Accordingly, in a further aspect, the disclosure provides a process for preparing a cross-linked block copolymer membrane, wherein the membrane comprises at least one block copolymer comprising residues of anthracene, which comprises exposing the block copolymer comprising residues of anthracene to ultraviolet light.

In this fashion, the methodologies as set forth above are believed to be useful in effecting cross-linking reactions between at least a portion of the residual carbon-carbon double bonds which are present within the block copolymer matrix. This cross-linking reaction is believed to result in a necessarily higher molecular weight polymer and one that exhibits improved resistance to solvents such as those used in photolithography. In this regard, exemplary photolithography solvents include n-butyl acetate, isopropyl alcohol, 2-ethoxyethyl acetate, xylenes, cyclohexanone, ethyl acetate, isopentyl ether, methyl-2-hydroxyisobutyrate, methyl isobutyl carbinol, methyl isobutyl ketone, isoamyl acetate, undecane, propylene glycol methyl ether, propylene glycol monomethyl ether acetate, and a mixed solution of propylene glycol monomethyl ether and propylene glycol monomethyl ether acetate (7:3) mixing ratio surface tension of 27.7 mN/m). Additional solvents, which are believed to be capable of purification using the membranes of the disclosure include ethanol, methanol, butanol, hexanol, heptanol, octanol, decanol, benzyl alcohol; amides such as N,N-dimethylacetamide, N,N-dimethylformamide, N-methyl-2-pyrrolidone, piperidine, morpholine, pyridine, diethylenetriamine, pyrrolidone, methoxyethane, tetrahydrofuran, dioxane, dimethoxyethane; esters such as n-butyl acetate, methyl acetate, ethyl acetate, propyl acetate, pentyl acetate, amyl acetate, methyl formate, ethyl formate, propyl formate, butyl formate, ethyl lactate, propyl lactate, ethylene glycol, propylene glycol, triethylene glycol, ethylene glycol monomethyl ether, propylene glycol monomethyl ether, triethylene glycol monomethyl ether, chloroform, hexane, decane, octane, cyclohexane, pentane, toluene, xylene, benzene, methyl ethyl ketone, octanone, nonanone, acetone, heptanone, hexanone, diisobutyl ketone phenylacetone, cyclohexanone, acetylacetone, propylene carbonate, acetonitrile, sulfolane, and dimethylsulfoxide, and mixtures thereof, along with mixtures with water.

As used herein, the term “block copolymers” refers to the simplest block copolymers which comprise two or more linear segments or “blocks” wherein adjacent segments include different constituent units, with only one constituent unit in each block. However, this simple architecture is not the only architecture that can result in self-assembly on the nano- and meso-scales. Such architectures, which will be referred to as complex block or copolymer architectures, can include, for example, intermediate non-repeating units between blocks (junction blocks) and varying end groups at the termini of chains. Even more complex block architectures and block copolymer architectures exist, wherein at least a portion of one block or at least a portion of one junction block or one or more end groups comprise a structure or composition more complex than a linear single constituent unit chain. Such complex architectures include but are not limited to: periodic or random mixtures of different constituent units in one or more blocks, graft copolymer blocks, ring blocks or block copolymers, gradient blocks, or cross-linked blocks. Any block copolymer architecture/topology that allows incompatible segments of the block copolymer to phase separate (self-assemble) into distinct domains and be processed using the methods disclosed to generate porous block copolymer materials is suitable.

Some examples of suitable block chemistries include, but are not limited to: Poly(isobutylene), Poly(isoprene), Poly(butadiene), Poly(propylene glycol), Poly(ethylene oxide), Poly(dimethylsiloxane), Poly(ethersulfone), Poly(sulfone), Poly(hydroxystyrene), Poly(methylstyrene), Poly(ethylene glycol), Poly(2-hydroxyethyl methacrylate), Poly(acrylamide), Poly(N,N-dimethylacrylamide), Poly(propylene oxide), Poly(styrene sulfonate), Poly(styrene), Poly(ethylene), Poly(vinyl chloride), Poly(2-(perfluorohexyl) ethyl methacrylate), Poly(tetrafluoroethylene), Poly(vinylidene fluoride), Poly(pentafluorostyrene), Poly(acrylic acid), Poly(2-vinylpyridine), Poly(4-vinylpyridine), Poly(3-vinylpyridine), Poly(N-isopropylacrylamide), Poly(dimethylaminoethyl methacrylate), Poly(glycidyl methacrylate), Poly(ethyleneimine), Poly(lactic acid), Poly(acrylonitrile), Poly(methyl acrylate), Poly(butyl methacrylate), Poly(methyl methacrylate), Poly(n-butyl acrylate), Poly(amic acid), Poly(isocyanate), Poly(ethyl cyanoacrylate), Poly(allylamine hydrochloride), or a substituted equivalent of any of the above, with the proviso that the block copolymer overall possesses at least some carbon-carbon double bond moieties within the polymer matrix which are available for cross-linking reactions, or as set forth above, possess anthracene moieties, capable of being subjected to a dimerization reaction.

Suitable block copolymer starting materials for the manufacture of the membranes of the disclosure include those with Mn of about 1×10³ to about 1×10⁷ g/mol and include diblock, triblock, BCPs of higher order (i.e., tetrablock, pentablock, etc.). Polydispersity index (PDI) of a block copolymer is the measure of heterogeneity of the size of molecules and shows the distribution of molar mass in the BCP sample. It is the ratio of average molar mass (Mw) and number-average molar mass (Mn). The PDI of at least one embodiment of a BCP as contemplated herein is in the range of about 1.0 to about 3.0.

Exemplary block copolymers useful as starting materials in this disclosure can be found in U.S. Pat. Nos. 10,711,111; and 9,527,041; and U.S. Patent Publication Nos. 2021/0040281; 2021/0370237; and 2009/0173694, the disclosures of which are incorporated herein by reference in their entireties.

One particular block copolymer starting material is the polymer known as poly(1,4-isoprene)-b-poly(styrene)-b-poly(vinyl pyridine), which is commercially available from Polymer Source, Inc. of Quebec, Canada.

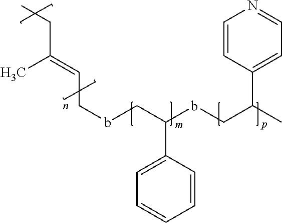

In such a structure, the residual carbon-carbon double bonds from the polymerization of isoprene monomers provides the platform for the cross-linking reaction.

The block copolymers useful in the disclosure can advantageously self-assemble into nanoscale structures and form uniformly sized micelles in casting solutions, which in turn, provides a highly ordered isoporous structure on the membrane's surface. See, for example, U.S. Patent Publication No. 2014/0217012, incorporated herein by reference, which describes the manufacture of filter membranes through a combination of controlled solvent evaporation and immersion precipitation processes, known as self-assembly and non-solvent induced phase separation (SNIPS).

Additionally, the membrane starting materials can be prepared by the methodology described in U.S. Patent Publication No. 2021/0040281, incorporated herein by reference in its entirety. In the cited methodology, the formation of a block copolymer film includes the steps of: (a) formulating a polymer solution by mixing at least one block copolymer, wherein at least one block copolymer is combined with at least one solvent; (b) extruding the polymer solution into a film on a nonporous substrate; (c) evaporating at least a portion of at least one chemical of the polymer solution; and (d) immersing the film into a coagulation bath.

Alternately, in the cited methodology for forming the block copolymer (freestanding or part of a composite) film also includes the steps of: (a) formulating a polymer solution by mixing at least one block copolymer, wherein at least one block copolymer is combined with at least one solvent; (b) extruding the polymer solution into a film on a nonporous substrate; (c) evaporating at least portion of at least one chemical of the polymer solution; (d) immersing the film into a coagulation bath; and (e) rinsing the block copolymer film.

The cross-linking reaction of the present disclosure can be conducted after the drying step, if the underlying membrane is sufficiently stable; if not, then the cross-linking reaction can be conducted on the membrane prior to drying. Thus, once dried, the cross-linked membrane substantially retains its pore structure. In this regard, we believe this cross-linking methodology will provide membranes which exhibit less than about 20 percent change, less than about 15 percent change, or less than about 10 percent change in bubble point when exposed to one or more photolithography solvents for a period of 24 hours. Additionally, the cross-linked membranes are believed to exhibit improved acid/base stability as well. By a bubble point test method, a sample of porous polymeric filter membrane is immersed in and wetted with a liquid having a known surface tension, and a gas pressure is applied to one side of the sample. The gas pressure is gradually increased. The minimum pressure at which the gas flows through the sample is called a bubble point. To determine the bubble point of a porous material a sample of the porous material is immersed in and wetted with ethoxy-nonafluorobutane HFE 7200 (available from 3M) at a temperature of 20-25° C. (e.g., 22° C.). A gas pressure is applied to one side of the sample by using compressed air and the gas pressure is gradually increased. The minimum pressure at which the gas flows through the sample is called the bubble point.

Once fabricated, the starting material membrane can be subjected to one or more of the techniques referred to above in order to achieve a desired level of cross-link density within the polymer matrix. Subsequently, the membrane can then be dried and fabricated into a desired filter structure.

A filter membrane as disclosed herein can be contained within a larger filter structure such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid chemical to cause at least a portion of the flow of the liquid chemical to pass through the filter membrane, so that the filter membrane removes an amount of the impurities or contaminants from the liquid chemical. The structure of a multi-layer filter assembly or filter cartridge may include one or more of various additional materials and structures that support the composite filter membrane within the filter assembly or filter cartridge to cause fluid to flow from a filter inlet, through the composite membrane (including the filter layer), and thorough a filter outlet, thereby passing through the composite filter membrane when passing through the filter. The filter membrane supported by the filter assembly or filter cartridge can be in any useful shape, e.g., a pleated cylinder, a cylindrical pad, one or more non-pleated (flat) cylindrical sheets, a pleated sheet, among others.

One example of a filter structure that includes a filter membrane in the form of a pleated cylinder can be prepared to include the following component parts, any of which may be included in a filter construction but may not be required: a rigid or semi-rigid core that supports a pleated cylindrical coated filter membrane at an interior opening of the pleated cylindrical coated filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric material.

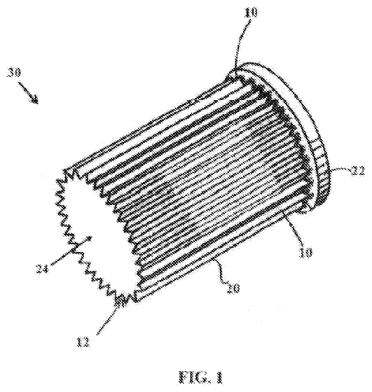

As one example, FIG. 1 shows filter component 30, which is a product of pleated cylindrical component 10 and end piece 22, with other optional components. Cylindrical component 10 includes a filter membrane 12, as described herein, and is pleated. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 30. The resultant pleated cylindrical component 30 with two opposed potted ends and optional core and cage can then be placed into a filter housing that includes an inlet and an outlet and that is configured so that an entire amount of a fluid entering the inlet must necessarily pass through filtration membrane 12 before exiting the filter at the outlet.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

### Aspects

In a first aspect, the disclosure provides a membrane comprising a cross-linked block copolymer.

In a second aspect, the disclosure provides a membrane comprising a cross-linked block copolymer, wherein the membrane exhibits less than about 20 percent change in bubble point when exposed to one or more photolithography solvents for a period of 24 hours.

In a third aspect, the disclosure provides the membrane of the first or second aspect, which is less than or equal to about 75 microns in thickness.

In a fourth aspect, the disclosure provides the membrane of any one of the first through the third aspects, wherein the copolymer is a terpolymer.

In a fifth aspect, the disclosure provides the membrane of any one of the first through the fourth aspects, wherein the membrane contains less than about 10 weight percent of a humectant.

In a sixth aspect, the disclosure provides the membrane of the fifth aspect, wherein the humectant is glycerin.

In a seventh aspect, the disclosure provides the membrane of any one of the first through the sixth aspects, wherein the membrane exhibits a tensile strain at break of greater than about 5 percent, by ASTM Method D638-14.

In an eighth aspect, the disclosure provides the membrane of any one of the first through the seventh aspects, wherein the cross-linked block copolymer is prepared from a block copolymer having residues of anthracene.

In a ninth aspect, the disclosure provides a composite membrane comprising a porous base layer and a cross-linked block copolymer layer.

In a tenth aspect, the disclosure provides a composite membrane comprising a porous base layer and a cross-linked block copolymer layer, wherein the membrane exhibits less than about 20 percent change in bubble point when exposed to one or more photolithography solvents for a period of 24 hours.

In an eleventh aspect, the disclosure provides the composite membrane of the ninth or tenth aspect, wherein the porous base layer is a nonwoven material.

In a twelfth aspect, the disclosure provides the composite membrane of the ninth, tenth, or eleventh aspect, wherein the porous base layer is chosen from a polyolefin or halogenated polyolefin polymer.

In a thirteenth aspect, the disclosure provides the composite membrane of any one of the ninth through the twelfth aspects, wherein the membrane is less than about 400 microns thick.

In a fourteenth aspect, the disclosure provides the composite membrane of any one of the ninth through the thirteenth aspects, wherein the porous base layer comprises a polymer chosen from polyethylene, polypropylene, polymethylpentene, polybutene, polyisobutylene, polymethylpentene, polybutene, polyisobutylene, and copolymers of two or more of ethylene, propylene, and butylene polyimides, polysulfones, polyether-sulfones, polyarylsulfone polyamides, polyacrylates, polyesters, polyamide-imides, celluloses, cellulose esters, polycarbonates, or combinations thereof.

In a fifteenth aspect, the disclosure provides the composite membrane of any one of the ninth through the fourteenth aspects, wherein the cross-linked copolymer is prepared from a block copolymer having residues of anthracene.

In a sixteenth aspect, the disclosure provides a filter comprising the membrane of the first or second aspect.

In a seventeenth aspect, the disclosure provides a filter comprising the composite membrane of the ninth or tenth aspect.

In an eighteenth aspect, the disclosure provides a process for preparing a cross-linked block copolymer membrane, the process comprising treatment of a block copolymer membrane having residual carbon-carbon double bonds, wherein the treatment is chosen from the group consisting of
a. treatment with a sulfur compound at temperatures sufficient to induce cross-linking;
b. treatment with a thermal free radical initiator at sufficient temperatures to induce cross-linking;
c. treatment with ultraviolet light in the presence of a free radical photoinitiator; and
d. exposure to electron beam radiation.

In a nineteenth aspect, the disclosure provides a process for preparing a cross-linked block copolymer membrane, wherein the membrane comprises at least one block copolymer comprising residues of anthracene, which comprises exposing the block copolymer comprising residues of anthracene to ultraviolet light.

In a twentieth aspect, the disclosure provides the process of the eighteenth aspect, wherein the method is option a. treatment with a sulfur compound at temperatures sufficient to induce cross-linking.

In a twenty-first aspect, the disclosure provides the process of he eighteenth aspect, wherein the method is option d. exposure to electron beam radiation.

In a twenty-first aspect, the disclosure provides the process of the eighteenth aspect, wherein the method is option b. treatment with a thermal free radical initiator.

In a twenty-second aspect, the disclosure provides the process of the eighteenth aspect, wherein the method is option c. treatment with a photo free radical initiator and the initiator is chosen from (2-hydroxy-4′-(2-hydroxyethoxy)-2-methylpropiophenone) or ammonium persulfate.

In a twenty-third aspect, the disclosure provides a process for preparing a composite membrane comprising:
a. a porous base layer; and a
b. cross-linked block copolymer membrane layer; wherein the membrane exhibits less than about 20 percent change in bubble point when exposed to one or more photolithography solvents for a period of 24 hours;
which comprises casting a bock copolymer having either residual carbon-carbon double bonds or anthracene moieties onto the porous base layer and subjecting the block copolymer membrane layer to a cross-linking reaction.

In a twenty-fourth aspect, the disclosure provides a process for preparing a composite membrane comprising:
a. a porous base layer; and a
b. cross-linked block copolymer membrane layer; wherein the membrane exhibits less than about 20 percent change in bubble point when exposed to one or more photolithography solvents for a period of 24 hours;
which comprises casting a bock copolymer having residual carbon-carbon double bonds onto the porous base layer to form a composite membrane, and treatment of the block copolymer membrane having residual carbon-carbon double bonds, wherein the treatment is chosen from the group consisting of
   i. treatment with a sulfur compound at temperatures sufficient to induce cross-linking;
   ii. treatment with a thermal free radical initiator at sufficient temperatures to induce cross-linking;
   iii. treatment with ultraviolet light in the presence of a free radical photoinitiator; and
   iv. exposure to electron beam radiation.

In a twenty-fifth aspect, the disclosure provides a process for preparing the composite membrane of the twenty-fourth aspect, wherein the method is option i. treatment with a sulfur compound at temperatures sufficient to induce cross-linking.

In a twenty-sixth aspect, the disclosure provides a process for preparing the composite membrane of the twenty-fourth aspect, wherein the method is option iv. exposure to electron beam radiation.

In a twenty-seventh aspect, the disclosure provides a process for preparing the composite membrane of the twenty-fourth aspect, wherein the method is option ii. treatment with a thermal free radical initiator.

In a twenty-eight aspect, the disclosure provides a process for preparing the composite membrane of the twenty-fourth aspect, wherein the method is option iii. treatment with a photo free radical initiator.

In a twenty-ninth aspect, the disclosure provides a process for preparing a composite membrane comprising:
a. a porous base layer; and a
b. cross-linked block copolymer membrane layer; wherein the membrane exhibits less than about 20 percent change in bubble point when exposed to one or more photolithography solvents for a period of 24 hours;
which comprises casting a bock copolymer having residual anthracene moieties onto the porous base layer to form a composite membrane, and treatment of the block copolymer comprising residues of anthracene to ultraviolet light.

1. A membrane comprising:
a cross-linked block copolymer, wherein the membrane exhibits less than about 20 percent change in bubble point when exposed to one or more photolithography solvents for a period of 24 hours.

2. The membrane of claim 1, wherein the membrane has a thickness of less than or equal to about 75 microns in thickness.

3. The membrane of claim 1, wherein the block copolymer of the cross-linked block copolymer is a terpolymer.

4. The membrane of claim 1, wherein the membrane contains less than about 10 weight percent of a humectant.

5. The membrane of claim 4, wherein the humectant is glycerin.

6. The membrane of claim 1, wherein the membrane exhibits a tensile strain at break of greater than about 5 percent, as measured by ASTM Method D638-14.

7. The membrane of claim 1, wherein the cross-linked block copolymer is prepared from a block copolymer having residues of anthracene.

8. The membrane of claim 1, wherein the membrane is a composite membrane comprising a porous base layer and a layer of the cross-linked block copolymer.

9. The membrane of claim 8, wherein the porous base layer is a nonwoven material.

10. The membrane of claim 8, wherein the porous base layer is chosen from a polyolefin or halogenated polyolefin polymer.

11. The membrane of claim 8, wherein the membrane has a thickness of less than or equal to about 400 microns.

12. The membrane of claim 8, wherein the porous base layer comprises a polymer chosen from polyethylene, polypropylene, polymethylpentene, polybutene, polyisobutylene, polymethylpentene, polybutene, polyisobutylene, and copolymers of two or more of ethylene, propylene, and butylene polyimides, polysulfones, polyether-sulfones, polyarylsulfone polyamides, polyacrylates, polyesters, polyamide-imides, celluloses, cellulose esters, polycarbonates, or combinations thereof.

13. A filter comprising the membrane of claim 1.

14. A method of using the membrane of claim 1, the method comprising passing a photolithography solvent through the membrane.

15. The method of claim 14, wherein the photolithography solvent is chosen from the group consisting of n-butyl acetate, isopropyl alcohol, 2-ethoxyethyl acetate, xylenes, cyclohexanone, ethyl acetate, isopentyl ether, methyl-2-hydroxyisobutyrate, methyl isobutyl carbinol, methyl isobutyl ketone, isoamyl acetate, undecane, propylene glycol methyl ether, propylene glycol monomethyl ether acetate, and combinations thereof.

16-25. (canceled)

26. The membrane of claim 1 wherein the block copolymer of the cross-linked block copolymer is poly(1,4-isoprene)-b-poly(styrene)-b-poly(vinyl pyridine).

27. A method of using the filter of claim 13, the method comprising passing a photolithography solvent through the membrane.
